(19) United States
(12) Patent Application Publication
(10) Pub. No.: US 2025/0043746 A1
(43) Pub. Date: Feb. 6, 2025

(54) AN ALPHA TYPE STIRLING ENGINE

(71) Applicant: EnergyIntel Services Ltd., Nicosia (CY)

(72) Inventors: Martin Nilsson, Nicosia (CY); Fredrik Slätte, Nicosia (CY); Johan Lindh, Nicosia (CY); Peter Weber, Nicosia (CY)

(73) Assignee: EnergyIntel Services Ltd., Nicosia (CY)

(21) Appl. No.: 18/717,624

(22) PCT Filed: Dec. 1, 2022
(86) PCT No.: PCT/SE2022/051129

§ 371 Date: Jun. 7, 2024

(30) Foreign Application Priority Data
Dec. 10, 2021 (SE) 2151516-8

(51) Int. Cl. F02G 1/045

(52) U.S. Cl. CPC F02G 1/045; F02G 2280/10

(57) ABSTRACT

An alpha type Stirling engine, comprising four pistons housed in respective chambers for reciprocating movement, at least two linear motors/generators configured to cause said pistons to move in the respective chambers, each one of said pistons defining in its respective chamber a primary chamber side located on one side of the piston and a secondary chamber side located on the other side of the piston. The Stirling engine comprises two primary gas channels, each one fluidly interconnecting two primary chamber sides. The Stirling engine also comprises two secondary gas channels, each one fluidly interconnecting two secondary chamber sides in different chamber combinations than the interconnections achieved by the primary gas channels.

### TECHNICAL FIELD

The present disclosure relates to an alpha type Stirling engine.

### BACKGROUND ART

Thermal energy can be converted into electrical energy in several ways. Some systems use Stirling engines as a generator to convert thermal energy to electrical energy. Stirling engines are closed-cycle engines which use an external heat source to expand a working gas which drives one or more pistons.

Furthermore, Stirling engines in combination with a thermal energy storage can be used to utilize excess power from e.g. photovoltaic power plants and wind turbines. Instead of curtailing the power when the output of such power plants exceeds electricity demand, the excess power is used to, for instance, charge the thermal energy storage, thus making it possible to later draw energy from said storage when demand for electricity exceeds available output from these intermittent renewable sources. It is then possible to use a Stirling engine to convert the thermal energy to electricity.

Although alpha type Stirling engines are advantageous, there is still room for improvement, in particular when it comes to the efficiency of the engines.

### SUMMARY OF THE INVENTION

An object of the present disclosure is to provide an alpha type Stirling engine having improved efficiency. This and other objects, which will become apparent in the following discussion, are achieved by an alpha type Stirling engine as defined in claim 1. Exemplary non-limiting embodiments are presented in the dependent claims.

The present inventive concept is based on the realization that four chambers, each housing a respective piston coupled to a linear motor/generator, may be fluidly interconnected in such a way that the forces required by at least two of the linear motors/generators may be reduced (i.e. requiring less power consumption). In particular, the inventors have realized that the four chambers may be pairwise fluidly interconnected in the normal way, but then additionally interconnecting a chamber of one pair with a chamber of the other pair. This will be discussed in more detail in the following.

According to at least one aspect of the present inventive concept, there is provided an alpha type Stirling engine, comprising:
a first piston, a second piston, a third piston and a fourth piston,
a first chamber, a second chamber, a third chamber and a fourth chamber, in which the first piston, the second piston, the third piston and the fourth piston, respectively are housed for reciprocating movement,
at least two linear motors/generators configured to cause said pistons to move in the respective chambers,
each one of said pistons defining in its respective chamber a primary chamber side located on one side of the piston and a secondary chamber side located on the other side of the piston,
a first primary gas channel, which fluidly interconnects the primary chamber side of the first chamber with the primary chamber side of the second chamber,
a second primary gas channel, which fluidly interconnects the primary chamber side of the third chamber with the primary chamber side of the fourth chamber,
a first secondary gas channel, which fluidly interconnects the secondary chamber side of the first chamber with the secondary chamber side of the fourth chamber, and
a second secondary gas channel, which fluidly interconnects the secondary chamber side of the second chamber with the secondary chamber side of the third chamber.

By having the above interconnection of the four chambers, the first and second chambers may be fluidly connected in the customary manner, by means of the first primary gas channel.

Similarly, the third and fourth chambers may also be connected in the customary manner by means of the second primary gas channel. Thus, two pairs of “customarily” connected chambers can be identified. However, by additionally cross-coupling the pairs, i.e. by providing the two secondary gas channels as disclosed above, an expansion movement of a piston in the chamber of one pair will supplement (by adding a pushing force) a compression movement of a piston in the chamber of another pair. Thus, this added force received from a chamber from a different pair results in less required motor force in the compression movement, and thereby a more efficient engine is achieved.

From the above it can be understood that general inventive concept provides for a Stirling engine which comprises two primary gas channels, each one fluidly interconnecting two primary chamber sides. The Stirling engine also comprises two secondary gas channels, each one fluidly interconnecting two secondary chamber sides in different chamber combinations (i.e. different chamber interconnections) than the interconnections achieved by the primary gas channels.

From the above it can also be understood that each one of the four chambers have at least two gas inlets, one gas inlet being in fluid communication with a primary gas channel and another gas inlet being in fluid communication with a secondary gas channel. For each chamber, said two gas inlets are spaced apart from each other at least in the axial direction of the chamber (the axial direction coinciding with the reciprocating movement of the piston in the chamber). In at least some exemplary embodiments, said two gas inlets are also spaced apart from each other in a radial direction (radial directions being perpendicular to the axial direction). It should also be understood that since gas will move back and forth through said gas inlets, they may also be referred to as “gas outlets”, or in more general terms “gas openings”.

For each one of said pairs of chambers, a suitable phase shift may be provided between movements of the pistons in the chambers of each pair, as is customary. Additionally, an appropriate phase shift of a piston in the chamber of one pair may suitably be provided relative to the piston in the chamber of another pair.

Advantageously, the compression stroke of the piston in one pair may suitably be (phase-wise) ahead of the expansion stroke of the piston in the other pair. For example, the first piston may suitably start its expansion stroke after the fourth piston has started its compression stroke.

Similarly, the third piston may suitably start its expansion stroke after the second piston has started its compression stroke. This will supplement the piston performing the compression motion rather than counteracting its motion.

According to at least one exemplary embodiment, said at least two linear motors/generators comprises a first linear motor/generator and a second linear motor/generator,
wherein the first linear motor/generator is configured to move a first piston rod, one end of the first piston rod being provided with the first piston and the opposite end of the first piston rod being provided with the third piston,
wherein the second linear motor/generator is configured to move a second piston rod, one end of the second piston rod being provided with the second piston and the opposite end of the second piston rod being provided with the fourth piston.

This provides a compact arrangement since each linear motor/generator can drive two pistons. Each linear motor/generator and its associated piston rod with the two pistons may be provided in a respective common module. Thus, there may suitably be provided two modules, wherein both primary gas channels and both secondary gas channels extend between the two modules. One of the modules may be an expansion module, the other one may be a compression module.

According to at least one exemplary embodiment, the alpha type Stirling engine comprises a first module and a second module, wherein the first linear motor/generator, the first piston, the first chamber, the third piston and the third chamber are located in said first module, wherein the second linear motor/generator, the second piston, the second chamber, the fourth piston and the fourth chamber are located in said second module.

In the above discussed exemplary embodiments, since the first piston and the third piston are provided at opposite ends of the first piston rod, they will automatically be phase-shifted by 180° relative to each other. For example, when the first piston starts its upward motion, the third piston will start its downward motion (relative to their respective top dead centers). In other words, when the first piston starts to move towards the secondary chamber side of the first chamber, then the third piston will simultaneously start to move towards the primary chamber side of the third chamber. Similarly, in the above exemplary embodiments, since the second piston and the fourth piston are provided at opposite ends of the second piston rod, they will also be phase-shifted by 180° relative to each other.

Although a compact arrangement as described above may be advantageous, the inventive concept is not limited to such embodiments. On the contrary in at least some exemplary embodiments, each piston is driven by a respective linear motor/generator. This is reflected in the below exemplary embodiment.

According to at least one exemplary embodiment, said at least two linear motors/generators are four linear motor/generators, each one of the linear motors/generators being configured to cause a respective one of said pistons to move in said respective chambers.

By only having a chamber on one side of the linear motor/generator, it may facilitate integration with other components of a complete Stirling engine. Since each linear motor/generator is associated with a respective piston, an individual control of the piston movements may be achievable, e.g. with respect to stroke length and/or motion profile. The linear motors/generators may be controlled by a control unit which may be configured to optimize the overall operation of the linear motors/generators. On the other hand, having only two linear motors/generators is cheaper and provides lower friction.

According to at least one exemplary embodiment, the alpha type Stirling engine comprises a first module, a second module, a third module and a fourth module, wherein the first chamber and first piston are located in the first module, wherein the second chamber and second piston are located in the second module, wherein the third chamber and the third piston are located in the third module, wherein the fourth chamber and the fourth piston are located in the fourth module. Each primary and secondary gas channel will thus extend from one module to another module.

By this arrangement, the second and fourth modules may be arranged with appropriate phase shifts relative to the first and third modules. This is at least partly reflected in the below exemplary embodiments.

According to at least one exemplary embodiment, in the reciprocating movements of said pistons:
the second piston is phase-shifted relative to the first piston by an angle −α,
the third piston is phase-shifted relative to the first piston by an angle of 170°-190°, such as by an angle of 180°,
the fourth piston is phase-shifted relative to the first piston by an angle of 170°-190°−α, such as by an angle of 180°−α.

By having the first piston and the third piston phase-shifted relative to each other by an angle of 180° the operational behaviour of the second piston may be the same as the operational behaviour of the fourth piston. Thus, a well-balanced overall system is obtainable.

It has been found that the extra pushing force in the compression stroke, enabled by means of the secondary gas channels as explained above, is at satisfactory level when the angle α is an angle in the range of 70°-135°, suitably 90°-120°.

As mentioned above the Stirling engine may be provided with a control unit. Such a control unit may be configured to individually control the movements of the piston. According to at least one exemplary embodiment, the control unit may be configured to control the phase shift between the pistons. In particular, according to at least one exemplary embodiment, the control unit may be configured to control the phase shift between the second piston and the first piston, and the phase shift between the fourth piston and the first piston, by setting a value for said angle α. By allowing the control unit to set the angle α, i.e. by allowing the control unit to set the phase shift between the pistons, it is possible to adapt the work of the Stirling engine to different operating demands. For instance, for any given user requirement, current operating demands, or the like, the control unit may select a value for the angle α so that the resulting efficiency and the resulting power output are appropriately balanced. Furthermore, the control unit may have the possibility to change the angle α based on which result you want to maximize, for example the efficiency or the power output. Just as an illustrative example, from a purely thermodynamic perspective in the primary gas channels, if a high efficiency is desired, the control unit may set a relatively high value for the angle α, for example around 120°, and if a high power output is desired, then the control unit may set a relatively low value for the angle α, for example around 90°. In practice, the control unit may be configured to take into account other parameters as well which effect the performance of the engine. Examples of such parameters may be the mass of the pistons and magnets.

According to at least one exemplary embodiment, the control unit may be configured to set a stroke length for each one of the first piston, the second piston, the third piston and the fourth piston, and to set the positions of the bottom dead centre and top dead centre for each piston in its respective chamber. In other words, the centre position of the stroke, i.e. halfway between the top dead centre and bottom dead centre may be set by the control unit. By setting the centre position of the stroke as well as the stroke length of each piston different control strategies are enabled. It may, for instance, be advantageous in situations in which a reduced power output may suffice. In such case, the control unit may reduce stroke length of the pistons compared to their maximum possible stroke length, and may further set the centre position of the reduced stroke. This gives an operator the possibility to configure the operating point with respect to the power output.

According to at least one exemplary embodiment the control unit may be configured to set the top dead centre of each piston as close as possible to the respective the primary gas channel. The control unit may, however, in such cases be configured to set the bottom dead centre differently for the different pistons, thereby setting different stroke lengths. In other exemplary embodiments the control unit may set the same stroke for all pistons, but set different top and bottom dead centres for two or more pistons. In other exemplary embodiments, the control unit may set the same top dead centre, bottom dead centre and stroke length for the first and the fourth pistons, while setting a different top dead centre, bottom dead centre and/or stroke length for the second and third pistons. For instance, the first and third pistons may in some scenarios be considered to represent “expansion” pistons having the same stroke pattern (but with appropriate phase shift), while the second and fourth pistons may be considered to represent “compression” pistons having another stroke pattern.

It should be understood that each one of the above discussed, and other, exemplary embodiments may include a control unit which is suitably configured to control the phase difference between the pistons (similarly to the function of any Stirling engine). In Stirling engines having mechanical linkage the phase difference is fixed by linkage. With the control unit, however, the phase difference may be adjusted electronically during operation. The control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where it includes a programmable device such as the microprocessor, microcontroller or programmable digital signal processor mentioned above, the processor may further include computer executable code that controls operation of the programmable device.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The above, as well as additional objects, features and advantages of the present invention, will be better understood through the following illustrative and non-limiting detailed description of exemplary embodiments of the present invention, wherein:

FIG. 1 schematically illustrates an alpha type Stirling engine according to at least one exemplary embodiment of the present disclosure.

FIG. 2 schematically illustrates an alpha type Stirling engine according to at least another exemplary embodiment of the present disclosure.

FIGS. 3a-3c schematically illustrate different configurations of the exemplary embodiment of FIG. 2.

FIG. 4 schematically illustrates additional components that may be included the exemplary embodiments illustrated in the previous drawing figures and in other exemplary embodiments.

### DETAILED DESCRIPTION

The present invention will now be described more fully hereinafter with reference to the accompanying drawings, in which exemplary embodiments of the invention are shown. The invention may, however, be embodied in many different forms and should not be construed as limited to the embodiments set forth herein; rather, these embodiments are provided for thoroughness and completeness.

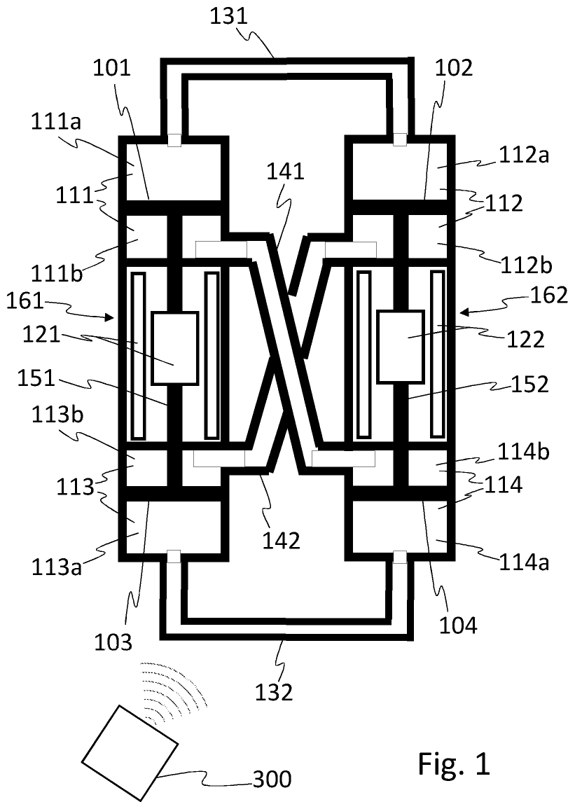

FIG. 1 schematically illustrates an alpha type Stirling engine according to at least one exemplary embodiment of the present disclosure. The Stirling engine comprises a first piston 101, a second piston 102, a third piston 103 and a fourth piston 104. The first piston 101 is provided inside a first chamber 111, the second piston 102 is provided inside a second chamber 112, the third piston 103 is provided inside a third chamber 113 and the fourth piston 104 is provided inside a fourth chamber 114. Each piston is arranged for a reciprocating movement within its respective chamber.

The Stirling engine comprises two linear motors/generators, namely a first linear motor/generator 121 and a second linear motor/generator 122. Each one of the linear motors/generators 121, 122 comprises a stator (winding) which surrounds a translator (magnet). A current through the stator induces an electromagnetic field causing the translator to move. The translator is connected to a respective piston rod 151, 152. Thus, the first linear motor/generator 121 is configured to move a first piston rod 151, and the second motor/generator 122 is configured to move a second piston rod 152. One end of the first piston rod 151 is provided with the first piston 101, and the opposite end of the first piston rod 151 is provided with the third piston 103. Similarly, one end of the second piston rod 152 is provided with the second piston 102, and the opposite end of the second piston rod 152 is provided with the fourth piston 104. Hereby, the first linear motor/generator 121 will, by moving the first piston rod 151 cause the first piston 101 and the third piston 103 to be moved synchronously but with a phase-shift of 180°. A corresponding movement of the second piston 102 and the fourth piston 104 is achieved by the second linear motor/generator 122.

Each one of the pistons 101-104, define in its respective chambers 111-114 a primary chamber side 111a-114a located on one side of the piston 101-104 and a secondary chamber side 111b-114b located on the other side of the piston 101-104.

A first primary gas channel 131 fluidly interconnects the primary chamber side 111a of the first chamber 111 with the primary chamber side 112a of the second chamber 112. A second primary gas channel 132 fluidly interconnects the primary chamber side 113a of the third chamber 113 with the primary chamber side 114a of the fourth chamber 114. The first primary gas channel 131, the primary chamber side 111a of the first chamber 111 and the primary chamber side 112a of the second chamber 112 together make up a closed first working gas volume. Similarly, the second primary gas channel 132, the primary chamber side 113a of the third chamber 113 and the primary chamber side 114a of the fourth chamber 114 together make up a closed second working gas volume.

A first secondary gas channel 141 fluidly interconnects the secondary chamber side 111b of the first chamber 111 with the secondary chamber side 114b of the fourth chamber 114. A second secondary gas channel 142 fluidly interconnects the secondary chamber side 112b of the second chamber 112 with the secondary chamber side 113b of the third chamber 113. The first secondary gas channel 141, the secondary chamber side 111b of the first chamber 111 and the secondary chamber side 114b of the fourth chamber 114 together make up a closed first buffer volume. The second secondary gas channel 142, the secondary chamber side 112b of the second chamber 112 and the secondary chamber side 113b of the third chamber 113 together make up a closed second buffer volume.

The working gas in the closed first working gas volume and the closed second working gas volume may, for instance, be helium, hydrogen, nitrogen or air, or a mixture thereof. The first and the second buffer volumes, may suitably contain the same type of gas as the first and second working gas volumes.

The Stirling engine comprises a first module 161 and a second module 162. The first linear motor/generator 121, the first piston 101, the first chamber 111, the third piston 103 and the third chamber 113 are located in the first module 161. The second linear motor/generator 122, the second piston 102, the second chamber 112, the fourth piston 104, and the fourth chamber 114 are located in the second module 162.

The first module 161 may comprise a cylinder part for the first piston 101 and another cylinder part for the third piston 103 and an intermediate housing for the first linear motor/generator 121 (said intermediate housing may also be cylindrical). The cylinder parts may suitably be releasably connectable to intermediate housing (e.g. via a flange) for enabling maintenance work or replacement of individual components within the housing and/or the cylinder parts. The second module 162 may, similarly comprise a cylinder part for the second piston 102 and another cylinder part for the fourth piston 104 and an intermediate housing for the second linear motor/generator 122 (to which the cylinder parts are releasably connectable). It can be understood that when the first piston 101 is moved towards secondary chamber side 111b of the first chamber 111 (i.e. mainly in the expansion stroke of the first piston 101), fluid will be pushed from the secondary chamber side 111b of the first chamber 111 through the first secondary gas channel 141 to the secondary chamber side 114b of the fourth chamber 114.

By controlling the fourth piston 104 to be phase-wise before the first piston 101, such that the upward stroke of the fourth piston 104 starts before the downward stroke of the first piston 101 (in this context upward and downward is defined relative the respective piston's top dead center), the extra pushing force of the fluid coming via the first secondary gas channel 141 will supplement the force provided by the second linear motor/generator 122. Therefore the second linear motor/generator 122 may be controlled to provide less electromagnetic force than what would be the case if the first secondary gas channel 141 would be omitted.

Similarly, because of the phase shift of 180° between the first piston 101 and the third piston 103, when the first piston 101 has completed its expansion stroke and is about to return in a direction towards the first primary gas channel 131, then the third piston 103 will start its expansion stroke. Fluid from the secondary chamber side 113b of the third chamber 113 will be pushed through the second secondary gas channel 142 and help pushing the second piston 102 in its compression stroke, and therefore less force is needed from the second linear motor/generator 122. As can be understood, because of the less force needed from the second linear motor/generator 122, a more energy efficient solution is achieved than what would be the case without the cross-wise connection of the two modules 161, 162 by means of the secondary gas channels 141, 142.

FIG. 1 furthermore illustrates a control unit 300 for controlling the operation of the first linear motor/generator 121 and the second linear motor/generator 122. As illustrated in FIG. 1, the control unit 300 may send control signals to the linear motors/generators 121, 122 by means of wireless communication. However, in other exemplary embodiments, the control unit 300 may instead or additionally send such control signals by means of wired communication. The control unit 300 is configured to control the linear motor/generators 121, 122 individually. For instance, the control unit 300 may set individual stroke lengths, frequencies, etc. for the linear motors/generators 121, 122, and may change the setting based on current demands, such as current power output and/or efficiency requirements.

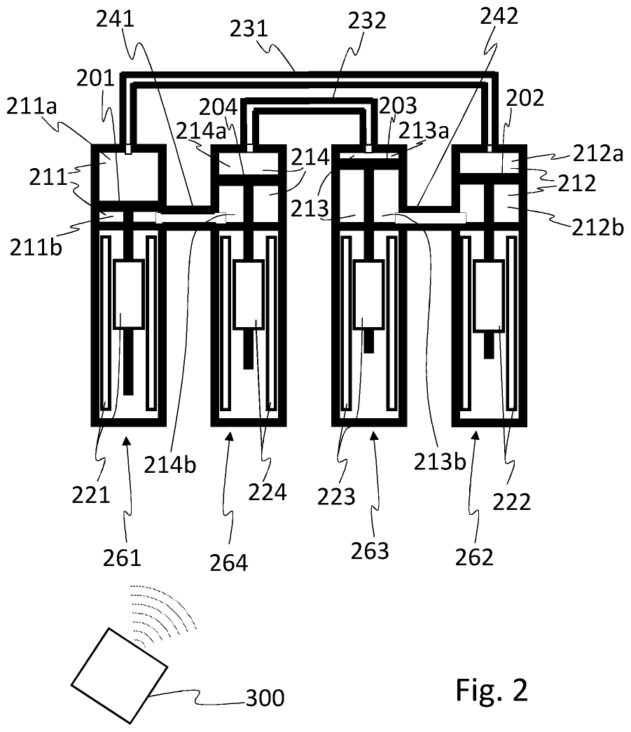

FIG. 2 schematically illustrates an alpha type Stirling engine according to at least another exemplary embodiment of the present disclosure. Also in this this exemplary embodiment there are provided four pistons 201-204 housed in respective chambers 211-214 for reciprocating movement. Similarly to FIG. 1, each chamber 211-214 in FIG. 2 has a primary chamber side and a secondary chamber side. Furthermore, similarly to FIG. 1, in the exemplary embodiment of FIG. 2, the primary chamber side 211a of the first chamber 211 is, by means of a first primary gas channel 231, fluidly interconnected with the primary chamber side 212a of the second chamber 212, and the primary chamber side 213a of the third chamber 213 is fluidly interconnected, by means of a second primary gas channel 232, with the primary chamber side 214a of the fourth chamber 214. Furthermore, the secondary chamber side 211b of the first chamber 211 is, by means of a first secondary gas channel 241, fluidly interconnected with the secondary chamber side 214b of the fourth chamber 214, and the secondary chamber side 212b of the second chamber 212 is, by means of second secondary gas channel 242, fluidly interconnected with the secondary chamber side 213b of the third chamber 213.

Similarly to the example in FIG. 1, in the example in FIG. 2, the primary gas channels 231, 232 and the primary chamber sides 211a, 212a; 213a, 214a, make up closed first and second working gas volumes. Likewise, the secondary gas channels 241, 242, the secondary chamber sides 211b, 214b; 212b, 213, make up closed first and second buffer volumes.

In the exemplary embodiment of FIG. 2, the Stirling engine comprises four linear motors/generators 221-224, each one being configured to cause a respective one of said pistons 201-204 to move their respective chambers 211-214.

In the exemplary embodiment of FIG. 2, there are presented four modules 261-264, which may be in the form of a first module 261, a second module 262, a third module 263 and a fourth module 264. The first chamber 211 and the first piston 201 are located in the first module 261, the second chamber 212 and the second piston 202 are located in the second module 262, the third chamber 213 and the third piston 203 are located in the third module 263, and the fourth chamber 214 and fourth piston 204 are located in the fourth module 264.

FIG. 2 further illustrates that the first linear motor/generator 221 is located within the first module, that the second linear motor/generator 222 is located within the second module 262, that the third linear motor/generator 223 is located within the third module 263, and that the fourth linear motor/generator 224 is located within the fourth module 264.

In analogy with the example in FIG. 1, in the example in FIG. 2 each module may comprise a cylinder part for the respective piston and a housing for the respective linear motor/generator, the cylinder part suitably being releasably connectable to the housing.

The operation of the exemplary embodiment of FIG. 2 substantially corresponds to that of the exemplary embodiment of FIG. 1. FIG. 2 is illustrated in a state in which the fourth piston 204 has already performed a part of its upwardly moving stroke within the fourth chamber 214. At this point in time, the first piston 201 will be in its lowest position within the first chamber 211, compressing the volume in the first secondary gas channel 241, while the fourth piston 204 compresses the gas in the second primary gas channel 232. Thus, the first piston 201 is somewhat ahead of the fourth piston 204 in their respective stroke that they are presently performing. As the first piston 201 completes its downward stroke fluid will be pushed from the secondary chamber side 211b of the first chamber 211 via the first secondary gas channel 241 to the secondary chamber side 214b of the fourth chamber 214, thereby supplementing the upwardly directed force provided by the fourth linear motor/generator 214. The corresponding supplemental pushing force will be provided by the third piston 203 at a later stage when it performs its downward stroke, whereby fluid will be pushed from the secondary chamber side 213b of the third chamber via the second secondary gas channel 242 to the secondary chamber side 212b of the second chamber 212, thereby providing a supplemental force to the second piston 202 in its compression stroke.

As mentioned previously in this disclosure the pistons may be phase-shifted relative to each other in an appropriate way. With reference to both FIGS. 1 and 2, in the reciprocating movements of said pistons:
the second piston 102, 202 may be phase-shifted relative to the first piston 101, 201 by an angle −α,
the third piston 103, 203 may be phase-shifted relative to the first piston 101, 201 by an angle of 180° (±10°),
the fourth piston 104, 204 may be phase-shifted relative to the first piston 101, 201 by an angle of 180°−α (±10°).

With reference to both FIGS. 1 and 2, the control unit 300 may be configured to control the phase shift between the second piston 102, 202 and the first piston 101, 201, and the phase shift between the fourth piston 104, 204 and the first piston 101, 201, by setting a value for said angle α. Furthermore, with reference to FIG. 2, the control unit 300 may also be configured to control the phase shift between the third piston 203 and the first piston 201. In particular, the control unit 300 may be configured to control the third piston 203 and the first piston 201 to be phase shifted by approximately 180°.

Furthermore, the control unit 300 may be configured to set a stroke length for each one of the first piston 101, 201, the second piston 102, 202, the third piston 103, 203 and the fourth piston 104, 204, and to set the positions of the bottom dead centre and top dead centre for each piston in its respective chamber. It should be understood that in the configuration illustrated in FIG. 1, the setting of the top and bottom dead centres of the first and third piston 101, 103 are dependent on each other, as is the setting of the top and bottom dead centres of the second and fourth pistons 102, 104, due to the pistons pairwise sharing of a common linear motor/generator. In the configuration of FIG. 2, however, the control unit 300 may set the top and bottom dead centres individually for each one of the four pistons 201, 202, 203, 204.

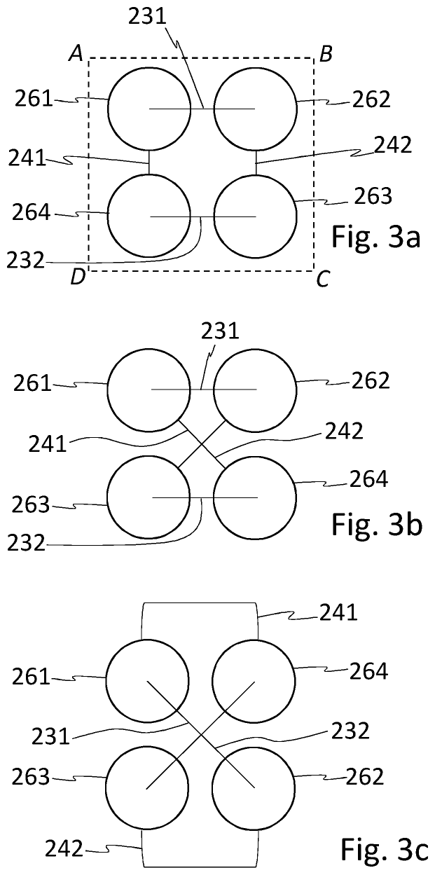

FIGS. 3a-3c schematically illustrate different configurations of the exemplary embodiment of FIG. 2. Before going into detail, it should be understood that each module 261-264 has a respective centre axis along which the respective piston 201-204 moves back and forth. FIGS. 3a-3c are schematic illustrations seen in a geometrical plane which is perpendicular to said centre axes of the four modules 261-264. As illustrated in FIG. 3a the four modules 261-264 may be circumscribed by an imaginary square (dashed line), wherein the centre axis of each module runs perpendicularly to the plane of the imaginary square and wherein each module 261-264 is located at a respective corner A-D of the imaginary square.

Although the imaginary square is not repeated in FIGS. 3b-3c, for the continued discussion it should be understood that the configurations in FIGS. 3b-3c may be circumscribed by the corresponding square with corners A-D. Furthermore, for the continued discussion, and for simplicity, the first module 261 is always located in the first corner A (see FIGS. 3a-3c). Going clockwise from the first corner A around the imaginary square, there is a second corner B, a third corner C and a fourth corner D.

As illustrated in FIG. 3a, the first module 261 is located in the first corner A, the second module 262 is located in the second corner B, the third module 263 is located in the third corner C and the fourth module 264 is located in the fourth corner D. As may be noted, in this configuration, the primary gas channels 231, 232 may run in parallel with each other. Likewise, the secondary gas channels 241, 242 may run in parallel with each other. This is a convenient configuration from an installation point of view.

In FIG. 3b, the third module 263 and the fourth module 264 have switched places. Thus, the third module 263 is now in the fourth corner D, while the fourth module 264 is in the third corner C. The primary gas channels 231, 232 may still run in parallel with each other.

However, due to the switching of the third module 263 and the fourth module 264, the secondary gas channels 241, 242 now run in a crosswise fashion.

In FIG. 3c, the fourth module 264 is located in the second corner B, the second module 262 is located in the third corner C and the third module 263 is located in the fourth corner D. Now the primary gas channels 231, 232 run in a crosswise fashion, while the secondary gas channels 241, 242 may run parallel to each other (or as illustrated in FIG. 3c parts of the secondary gas channels 241, 242 may run parallel to each other).

Each one of the illustrated configurations in FIGS. 3a-3c result in a compact arrangement of the modules 261-264.

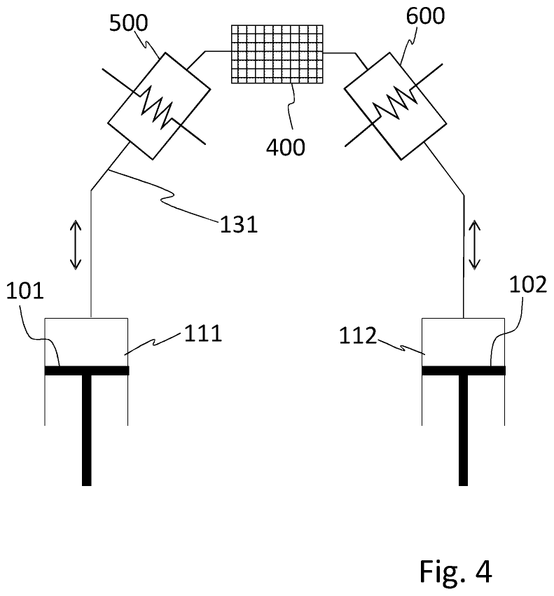

Furthermore, although not illustrated in FIGS. 1, 2, 3a-3c, it should be understood that the primary gas channels 131, 132, 231, 232 may each be associated with a regenerator, a cooler and a heater in the normal manner for Stirling engines. This will now be discussed in connection with FIG. 4.

FIG. 4 schematically illustrates additional components that may be included the exemplary embodiments illustrated in the previous drawing figures and in other exemplary embodiments.

For simplicity, reference will now be made to the first primary gas channel 131 in FIG. 1 and the associated the first chamber 111 and second chamber 112. It should, however, be understood that the same principle applies to the second primary gas channel 132 in FIG. 1 as wells the primary gas channels 231, 232 in FIG. 2 and in any other primary gas channel in other embodiments of the general inventive concept.

Thus, turning to FIG. 4, as previously explained the first primary gas channel 131 fluidly interconnects the primary chamber side of the first chamber 111 with the primary chamber side of the second chamber 112. The working gas within the primary gas channel 131 will be displaced back and forth due to the reciprocating movement of the first and second pistons 101, 102. A regenerator 400 is provided at the first primary gas channel 131. There is also provided a heater 500 and a cooler 600. From a fluid path perspective, the first chamber 111 and the heater 500 are provided on one side of the generator 400, while the second chamber 112 and the cooler 600 are provided on another side of the generator. Thus, the first chamber 111 may be regarded as the hot chamber or “hot cylinder”, while the second chamber 112 may be regarded as the cold chamber or “cold cylinder”, as often refer to in connection with Stirling engines.

As mentioned above, the same principles may be applied in the other primary channels discussed herein as well. For example, with reference to the exemplary embodiment of FIG. 2, from a fluid path perspective, the first and third modules 261, 263 and respective heaters may be provided on one side of respective regenerators (in the respective primary channels 231, 232), while the second and fourth modules 262, 264 and respective coolers may be provided on the other side of said regenerators. For instance, in FIG. 2, a regenerator may be provided at first primary gas channel 231, and the first chamber 211 and the heater would be located on one side of the regenerator while the second chamber 212 and the cooler would be located on the other side of the regenerator. Similarly, a regenerator may be provided at the second primary gas channel 232, and the third chamber 203 and the heater would be located on one side of the regenerator while the fourth chamber 204 and the cooler would be located on the other side of the regenerator.

The previously discussed control unit 300, or another control unit, may suitably be configured to control the medium flowing through the heaters and the coolers for achieving an appropriate heat exchange with the working gas in the primary gas channels.

From the above, it may be understood that according to at least some exemplary embodiments, the first module and the third module may be hot modules, while the second module and the fourth module may be cold modules.

As already explained previously, the purpose of the secondary gas channels is to act provide an extra push. There is thus no need for providing any thermal exchange with the gas in the secondary gas channels. Therefore, contrary to the primary gas channels, the secondary gas channels should suitably be void of any regenerator, heater and cooler.

Finally, it should be understood that although the main purpose of the Stirling engine of this disclosure is to generate electric energy (similarly to other Stirling engines, the working principle being well known and does therefore not need to be discussed in detail herein), the Stirling engine may also be used for cooling purposes, e.g. for freezers or the like. This is possible if no heat is added to the heaters (e.g. keeping the heaters at room temperature), which will lead to the medium in the heaters becoming very cold, and may thus be used for cooling other components, installations, etc. For such cooling implementations, a cryogenic liquid may, for instance, be used as the medium in the heaters.

1. An alpha type Stirling engine, comprising
a first piston (101, 201), a second piston (102, 202), a third piston (103, 203) and a fourth piston (104, 204),
a first chamber (1l1, 211), a second chamber (112, 212), a third chamber (113, 213) and a fourth chamber (114, 214), in which the first piston (101, 20l), the second piston (102, 202), the third piston (103, 203) and the fourth piston (104, 204), respectively are housed for reciprocating movement,
at least two linear motors/generators (121, 122, 221, 222, 223, 224) configured to cause said pistons to move in the respective chambers,
each one of said pistons defining in its respective chamber a primary chamber side (111a, 112a, 113a, 114a, 211a, 212a, 213a, 214a) located on one side of the piston and a secondary chamber side (111b, 112b, 113b, 114b, 211b, 212b, 213b, 214b) located on the other side of the piston,
a first primary gas channel (131, 231), which fluidly interconnects the primary chamber side (111a, 211a) of the first chamber (111, 211) with the primary chamber side (112a, 212a) of the second chamber (112, 212),
a second primary gas channel (132, 232), which fluidly interconnects the primary chamber side (113a, 213a) of the third chamber (113, 213) with the primary chamber side (114a, 214a) of the fourth chamber (114, 214),
a first secondary gas channel (141, 241), which fluidly interconnects the secondary chamber side (111b, 211b) of the first chamber (111, 211) with the secondary chamber side (114b, 214b) of the fourth chamber (114, 214), and
a second secondary gas channel (142, 242), which fluidly interconnects the secondary chamber side (112b, 212b) of the second chamber (112, 2112) with the secondary chamber side (113b, 213b) of the third chamber (113, 213).

2. The alpha type Stirling engine according to claim 1, wherein said at least two linear motors/generators comprises a first linear motor/generator (121) and a second linear motor/generator (121),
wherein the first linear motor/generator (121) is configured to move a first piston rod (151), one end of the first piston rod (151) being provided with the first piston (101) and the opposite end of the first piston rod (151) being provided with the third piston (103),
wherein the second linear motor/generator (122) is configured to move a second piston rod (152), one end of the second piston rod (152) being provided with the
second piston (102) and the opposite end of the second piston rod (152) being provided with the fourth piston (104).

3. The alpha type Stirling engine according to claim 2, comprising a first module (161) and a second module (162), wherein the first linear motor/generator (121), the first piston (1101), the first chamber (111), the third piston (103) and the third chamber (113) are located in said first module (161), wherein the second linear motor/generator (122), the second piston (102), the second chamber (112), the fourth piston (104) and the fourth chamber (114) are located in said second module (162).

4. The alpha type Stirling engine according to claim 1, wherein said at least two linear motors/generators are four linear motor/generators (221, 222, 223, 224), each one of the linear motors/generators being configured to cause a respective one of said pistons (201, 202, 203, 204) to move in said respective chambers (211, 212, 213, 214).

5. The alpha type Stirling engine according to claim 4, comprising a first module (261), a second module (262), a third module (263) and a fourth module (264), wherein the first chamber (211) and first piston (201) are located in the first module (261), wherein the second chamber (212) and second piston (202) are located in the second module (262), wherein the third chamber (2.13) and the third piston (203) are located in the third module (263), wherein the fourth chamber (214) and the fourth piston (204) are located in the fourth module (264).

6. The alpha type Stirling engine according to claim 1, wherein, in the reciprocating movements of said pistons:
the second piston (102, 202) is phase-shifted relative to the first piston (101, 201) by an angle −α,
the third piston (103, 203) is phase-shifted relative to the first piston (101, 201) by a third piston angle of 170°-190°,
the fourth piston (104, 204) is phase-shifted relative to the first piston (101, 201) by a fourth piston angle of 170°-190°−α.

7. The alpha type Stirling engine according to claim 6, wherein the angle α is in the range of 70°-135°.

8. The alpha type Stirling engine according to claim 6, further comprising a control unit, wherein the control unit (300) is configured to control the phase shift between the second piston (102, 202) and the first piston (101, 201), and the phase shift between the fourth piston (104, 204) and the first piston (101, 201), by setting a value for the angle α.

9. The alpha type Stirling engine according to claim 8, wherein the control unit (300) is configured to set a stroke length for each one of the first piston (101, 201), the second piston (102, 202), the third piston (103, 203) and the fourth piston (104, 204), and to set the positions of the bottom dead centre and top dead centre for each piston in its respective chamber.

10. The alpha type Stirling engine according to claim 6, wherein at least one of the third piston angle or the fourth piston angle is 180°.

11. The alpha type Stirling engine according to claim 6, wherein both the third piston angle or the fourth piston angle are 180°.

12. The alpha type Stirling engine according to claim 7, wherein the angle c; is in the range of 90°-120°.
